(19) United States
(12) Patent Application Publication
(10) Pub. No.: US 2009/0205018 A1
(43) Pub. Date: Aug. 13, 2009

(54) METHOD AND SYSTEM FOR THE SPECIFICATION AND ENFORCEMENT OF ARBITRARY ATTRIBUTE-BASED ACCESS CONTROL POLICIES

(76) Inventors: David F. Ferraiolo, Leesburg, VA (US); Serban I. Gavrila, Chevy Chase, MD (US)

Correspondence Address: CARLSON, GASKEY & OLDS, P.C., 400 WEST MAPLE ROAD, SUITE 350, BIRMINGHAM, MI, 48009, US

(21) Appl. No.: 12/366,855

(22) Filed: Feb. 6, 2009

Related U.S. Application Data
(60) Provisional application No. 61/026,743, filed on Feb. 7, 2008.

(51) Int. Cl. H04L 9/00; G06F 17/30

(52) U.S. Cl. 726/1; 707/103 R; 707/E17.055

(57) ABSTRACT

A general attribute-based access control system includes at least one resource server, at least one client module, an access control database including basic data sets and basic relations between the basic data sets, at least one server module including an access decision sub-module that computes a decision whether to grant or deny access to computer-accessible resources referenced by objects, an event processing sub-module that processes events, and an administrative sub-module that creates, deletes, and modifies elements of the basic data sets and the basic relations.

### RELATED APPLICATION

This application claims priority to U.S. Provisional Application Ser. No. 61/026,743, which was filed Feb. 7, 2008.

### BACKGROUND OF THE INVENTION

Access control mechanisms are a major component of any operating system and many applications. Access control policies come in numerous forms, with various methods for authenticating users, access control data constructs for specifying and managing policy, functions for making access control decisions and enforcement of policies, and a scope of protection that includes a defined set of users and resources.

One drawback of having multiple heterogeneous access control mechanisms is a lack of interoperability. Access control policies are often global and span many systems and applications. Users with vastly different attributes and credentials have a need to access resources protected under different mechanisms, and resources that are protected under different mechanisms differ vastly in their sensitivity, and therefore accessibility. This lack of interoperability introduces significant privilege and identity management challenges.

Another drawback to the existing approach to access control pertains to policy enforcement. Operating systems limit enforcement to instances of Discretionary Access Control (DAC), simple variations of Role-based Access Control (RBAC) policies, and Multi-level Security (MLS) policies. However, issues exist even within the enforcement of this narrow set of policies. DAC and RBAC are considered weak in that that users (through overt actions and mistakes) and malicious code embedded within applications can potentially leak sensitive data to unauthorized users. Also, objects are also often under-protected under DAC and RBAC alone. For example, although access to medical records may be restricted to users in the role “Doctor,” not all doctors may have access to all medical records. Depending on the institution, other policies may come into play. Medical records can be classified, only accessible to those doctors in a particular ward, or accessible only under the discretionary permission of a primary physician. Additionally, MLS mechanisms can impose user and administrative inconveniences. As traditionally implemented, MLS policies impose restrictions uniformly on users and their processes thereby a user within a session is prevented access to information for which that user is otherwise legitimately authorized.

One partial solution to meet policy needs not provided by operating systems is to implement access control mechanisms within applications, such as database management systems, enterprise calendars, and time and attendance calendars. Typically, any application that requires user authentication usually includes access control mechanisms. This proliferation of access control mechanisms further aggravates identity and privilege management problems and can undermine policy enforcement objectives. For instance, although an operating system may narrowly restrict user access to a specific file, a user with read access to the file can copy the file to a message and mail the message to anyone in the organization.

Another partial solution to meet general policy needs is an OASIS' standard eXtensible Access Control Markup Language (XACML) that describes both a policy language and an access control decision request/response language (both encoded in XML). The policy language describes general access control requirements. The request/response language allows for queries to ask whether a given action should be allowed and interpret the result. One drawback of XACML is that it does not specify or enforce policies that pertain to processes in isolation to their users, thereby disallowing the specification and enforcement of a wide variety of related policies. Another drawback of XACML is that its Policy Decision Point is stateless, which further place limitations on the policies that can be specified and enforced.

Another partial solution would be to use various configurations of Role-Based Access Control relations to simulate Mandatory Access Control and Discretionary Access Control policies. This was demonstrated by Sylvia Osborn, Ravi Sandhu and Qamar Munawer, in “Configuring Role-Based Access Control to Enforce Mandatory and Discretionary Access Control Policies,” ACM Transactions on Information and Systems Security (TISSEC), Volume 3, Number 2, February 2000, using the RBAC96 model. One drawback to this approach is that Osborn et al. applied a series of obligation relations in the configuration of these policies that can only exist in theory, and are not specified in the RBAC96 model. Another drawback is that their strategy for simulating DAC requires the creation of a multitude of roles that would exceed the number of objects in the system. Simulating MAC also requires the creation of role-permission assignment relations that exceed the number of objects.

Another partial solution was proposed by David Ferraiolo, Serban Gavrila, Vincent Hu, Richard Kuhn in “Composing and combining policies under the Policy Machine,” SACMAT '05, Jun. 1-3, 2005, Stockholm, Sweden. A drawback of the Ferraiolo et al. is the limitation and inefficiency in specifying and enforcing policy. The framework required the costly computation and activation of a set of user attributes for a set of processes running in a session, in order to gain access to a resource. Further drawbacks include the lack of control at the individual process level, the lack of constraints on users and processes, and the inability to dynamically alter the policy state of the machine in support of the specification and enforcement of policy.

### SUMMARY OF THE INVENTION

An exemplary general attribute-based access control system includes at least one resource server, at least one client module, an access control database including basic data sets and basic relations between the basic data sets, at least one server module including an access decision sub-module that computes a decision whether to grant or deny access to computer-accessible resources referenced by objects, an event processing sub-module that processes events, and an administrative sub-module that creates, deletes, and modifies elements of the basic data sets and the basic relations.

An exemplary general attribute-based access control method includes selecting an attribute-based access control policy for specification and enforcement, establishing a configuration of basic data sets in an access control database for the selected attribute-based access policy, and establishing a configuration of basic relations between the basic data sets to control how the policy is enforced.

### BRIEF DESCRIPTION OF THE DRAWINGS

The various features and advantages of the disclosed examples will become apparent to those skilled in the art from the following drawings that accompany the detailed description. The drawings can be briefly described as follows.

FIG. 1 illustrates the architecture of a general attribute-based access control system.

FIG. 2 illustrates the basic data sets and relations and the mapping of objects to their physical locations.

FIG. 3 illustrates an example of assignment relations in support of combined RBAC and MLS policies.

FIG. 4 illustrates a derivation of a capability of a user in a single policy class from the assignment relations.

FIG. 5 illustrates a derivation of a permission from the assignment relations.

FIG. 6 illustrates an object attribute (or container) that is accessible to a user.

FIG. 7 illustrates an example presentation of a personal object system (POS) with respect to FIG. 3.

FIG. 8 illustrates a portion of assignment relations that are configured to support a Discretionary Access Control (DAC) policy objective.

FIG. 9 illustrates a portion of assignment relations that are configured to support a Discretionary Access Control (DAC) policy objective, where user BOB has been granted read and write access to object PROPOSAL1.

FIGS. 10a-e illustrate portions of an assignment relation configured for the support of a workflow application.

### DETAILED DESCRIPTION OF THE PREFERRED EMBODIMENT

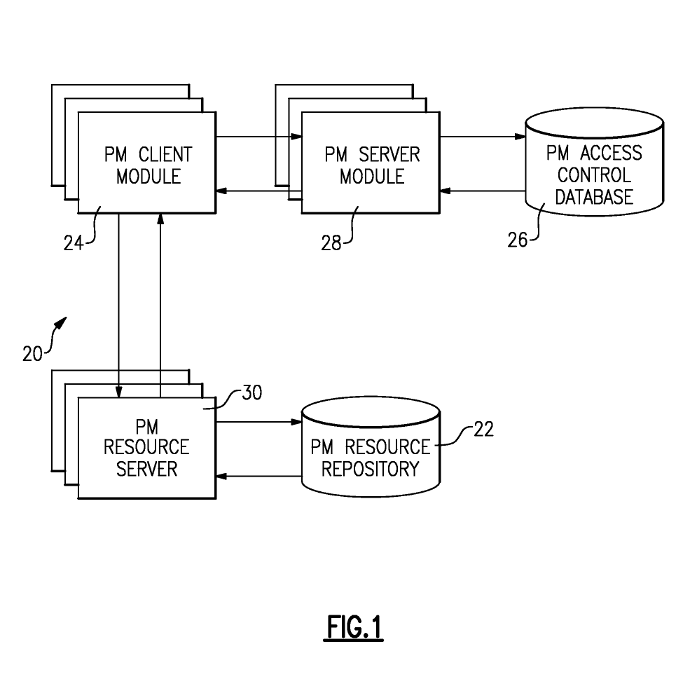

FIG. 1 illustrates the architecture of a general attribute-based access control system 20 (the “system 20”) for the specification and enforcement of arbitrary attribute-based access control policies. The system 20 may also be referred to as a “policy machine,” or “PM,” and includes one or more resource repositories 22, one or more client modules 24, an access control database 26, one or more server modules 28, and one or more resource servers 30.

The resource server 30 stores and retrieves computer-accessible resources referenced by objects to and from the resource repositories 22. The client module 24 authenticates users through an authentication scheme that maps human users to identifiers, executes programs within processes that run on behalf of authenticated users and are identified through unique process identifiers, issues access requests to perform operations on objects, and enforce access control policies with respect to the access requests. The access control database 26 includes basic data sets and basic relations between the basic data sets for specifying policy.

The basic data sets include data corresponding to the users, user attributes, objects, object attributes, operations, policy classes, and processes. The basic relations include assignments, prohibitions, and obligations. The assignments are used to derive permissions consisting of a user, an operation, and an object, where the pair operation, object is said to be a capability of the user. The prohibitions are representations of the capabilities of the users that are denied to users and processes. The obligations include conditions under which basic data sets and relations are obligated to change in a manner also prescribed in the obligations. The server module 28 computes decisions whether to grant or deny access to a resource referenced by an object to a process, processes events raised by the successful execution of an operation on an object, and assists in the administration of the access control database.

The client module 24 provides the context in which the user's PM processes run. A user may log on to the PM by using an authentication sub-module of the client module 24. A successful login may open a user session for creating and running various PM processes that request access to objects. A policy enforcement sub-module of the client module 24 traps each access request, and then asks the server module 28 to decide whether to grant or deny the access request. The server module 28 computes and returns the decision to grant or deny the access request to the process that issued it. In the case of a decision to grant, if the resource referenced by the object of the access request is stored in a repository, the server module 28 also returns the resource's physical location. The policy enforcement sub-module of the client module 24 enforces the decision received from the server module 28, granting or rejecting access to the object. For a granted request the client module 24 may require the cooperation of the resource server 30 in performing the granted operation on the resource. The resource server 30 may reside on the same computer as the client module, or on a server dedicated to the storage of PM resources.

The server module 28 is a software module that receives an access request from the client module, computes a decision to grant or reject the access request, and returns the result. The decision is based on the identity of the user, the identity of the process that issued the request, the requested operation, the requested object, and the assignment and prohibition relations as stored in the access control database 26, as will be described below. The server module 28 also executes the responses to events specified in the obligation relations stored in the access control database 26 and raised by a client's successful execution of an operation on an object. Finally, the server module 28 can be used to administer the access control database. The server module 28 exposes a standard set of commands that can be used by clients to solicit its services.

The system 20 provides a method that may be used to specify and enforce an arbitrary attribute-based access control policy. The method may include configuring the access control database to specify a desired policy (i.e., establishing the basic data sets and relations between the basic data sets), authenticating users and establishing and running processes within a session, trapping process access requests of the form (operation, object), computing decisions to grant or reject such requests by applying a reference mediation function, which determines the existence of a permission (user, operation, object) derived from the assignment relations such that the user is the process user, and the capability (operation, object) of the user is not denied for either the user or the process through prohibitions, and dynamically altering the current configuration of the access control database as prescribed by obligation relations that specify the conditions and the manner in which such alteration must take place.

FIG. 2 illustrates an example structure 40 of the basic relationships of assignments, prohibitions, and obligations between the basic data sets for defining a policy. The configuration of assignments and prohibitions defines the access state, and the access state and the obligation relations define the overall policy. The current access state defines the set of permissible user and subject (processes) accesses. Obligations may dynamically alter relations to include current access relations and obligations as a response to subjects accessing resources.

In the disclosed examples, some of the basic data sets are denoted as users (U), system operations (OP), objects (O) and processes (P). Users are unique identifiers associated to human users through an authentication scheme.

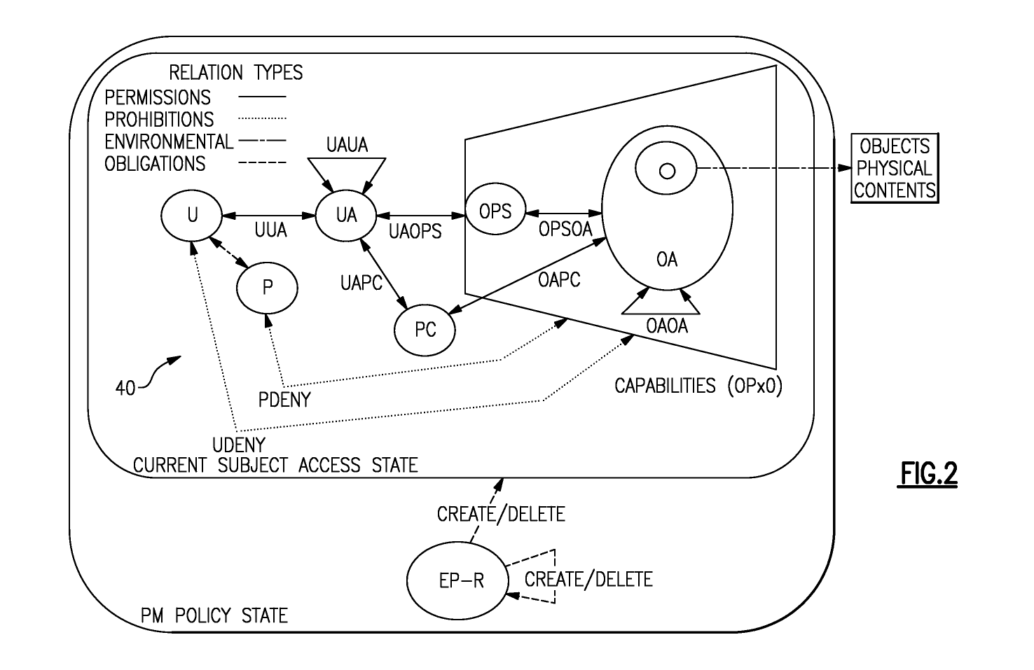

Objects are names (with global meaning) for computer accessible resources that must be protected, and perhaps shared, under one or more access control policies. For example, FIG. 3 presents an example of assignment relations where project1 and mrec1 are objects. The set of objects may pertain to files, ports, clipboards, email messages, records and fields. The selection of entities included in this set is a matter of choice determined by the protection requirements of the system. The system 20 maintains the association between the logical object names and the corresponding resources (e.g., files or the system clipboard).

Operations are actions that can be performed on the protected resources. Subsets of these operations are environment specific. For example, in an operating system environment, operations may include read (r) and write (w) operations. The operations may also include a fixed set of administrative operations that create, modify and delete data and relations of the access control database.

The system 20 may also define user attributes (UA) and object attributes (OA). User and object attributes characterize users/objects and serve as user/object containers. Each object is also considered to be an attribute of itself, i.e., O ⊂ OA. User attributes, respectively object attributes included in FIG. 3 are Doctor and Secret, respectively mrec1, Med Records, and TS (for top secret). However, containers can satisfy a variety of uses. Containers may represent folders (e.g., “DHS Proposals”), application-specific work areas (e.g., “Smith Inbox”), or a column in a database table (e.g., “Diagnosis”).

The system 20 has the ability to configure instances of access control policies, as well as combinations of different access control policies, named policy classes as denoted by PC. FIG. 3 includes two policy classes, RBAC and MLS, which refer to the policy objectives rather than the way the objectives are enforced.

Also included in FIG. 2 is a set of processes (P). Each process is associated with a single user. A user may have multiple processes running at any one time. The function process_user: P→U associates a process with its user.

The following summarizes the definitions:

U denotes the set of users.

UA denotes the set of user attributes.

O denotes the set of PM objects.

OA denotes the set of object attributes, with O⊂OA (each object is an object attribute).

OP is the set of system operations.

PC denotes the set of policy classes.

P denotes the set of processes.

The sets of event pattern/response relations (EP-R), user denies (UDENY) and process denies (PDENY) are described below with respect to the relevant relations.

### Assignment Relations

Assignments are binary relations denoted by “→.” Users are assigned to one or more user attributes and objects are assigned to zero or more object attributes. For example, the user with the identifier “alice” of FIG. 3 is assigned to “Doctor” and Top Secret” and the object “mrec1” is assigned to “Med Records” and “TS.”

A user attribute may be assigned to another user attribute and an object attribute may be assigned to another object attribute. The second object attribute cannot be an object. The only other restriction on assignments is that any chain of attribute assignments cannot be a cycle.

A user attribute may be assigned to one or more operation sets ops, with ops⊂OP. In turn, those operation sets may be assigned to object attributes. Abbreviated notations may be used to illustrate these assignments. For example, Doctor

$${}^{w}$$

Med Records may be used instead of Doctor→{w}→Med Records. As discussed below, these assignment relations indirectly derive the capabilities and permissions, which are fundamental in performing and managing access control.

Not all users (and their processes) are controlled under all policies, nor are all user attributes and object attributes relevant to all policies. To afford appropriate policy class mappings, users, user attributes, objects and object attributes are associated with relevant policy classes through assignment relations (a user can be assigned to a policy class only through one or more user attributes). A user or user attribute “belongs to” or “is contained in” a policy class if there exists a chain of one or more assignments that starts with that user or user attribute and ends with the policy class. Similarly, an object or object attribute “belongs to” or “is contained in” a policy class if there exists a chain of one or more assignments that starts with that object or object attribute and ends with the policy class. In FIG. 3, the object project1 is protected (contained in) only under the RBAC policy class, while mrec2 is protected under (contained in) both RBAC and MLS.

The following summarizes the definitions:

UUA ⊂ U×UA denotes the user-to-user-attribute assignment relation.

UAUA ⊂ UA×UA denotes the user-attribute-to-user-attribute assignment relation, which has no cycles.

OAOA ⊂ OA×(OA−O) denotes the object-attribute-to-object-attribute assignment relation, which has no cycles.

UAOPS ⊂ UA×2^{OP} denotes the user-attribute-to-operation-set assignment relation.

OPSOA ⊂ 2^{OP}×OA denotes the operation-set-to-object-attribute assignment relation.

UAPC ⊂ UA×PC denotes the user-attribute-to-policy-class assignment relation.

OAPC ⊂ OA×PC denotes the object-attribute-to-policy-class assignment relation.

### Conventions

The following conventions are used throughout the remainder of this description. The notations→*respectively→⁺denote a chain of zero or more assignments, respectively a chain of one or more assignments. For example, consider the assignments illustrated in FIG. 3 where bob→Doctor→Intern→RBAC. In this case, one could write bob→⁺RBAC (or bob→*RBAC). Also, one could write bob→*bob but not bob→⁺bob. Also, user u is said to “have a user attribute” ua if u→⁺ua, and object o is said to “have an object attribute” oa if o→*oa.

### Permission Relations

Permissions are assertions regarding the capabilities of users and their processes in performing operations on objects, irrespective of any known exceptions. Permissions are triples of the form (u, op, o) indicating that a user u∈U is able to perform operation op∈OP on the contents of object o∈O.

Referring to FIG. 4, the set of capabilities of a user u∈U in a policy class pc∈PC is caps_{pc}(u)={(op, o)|∃ops∈2^{OP}, ∃oa∈OA, ∃ua∈UA: u→⁺ua→⁺pc, o→*oa→⁺pc, ua→ops→oa, op∈ops}.

Referring to FIG. 3, the capabilities of alice in RBAC, caps_{RBAC}(alice)={(r, mrec1), (w, mrec1), (r, mrec2), (w, mrec2), (r, mrec3), (w, mrec3)} because alice→Doctor→{w}→Med Records, alice→⁺Intern→{r}→Med Records, Doctor→⁺RBAC, Intern→⁺RBAC and mrec1, mrec2, mrec3 are assigned to Med Records and Med Records→⁺RBAC.

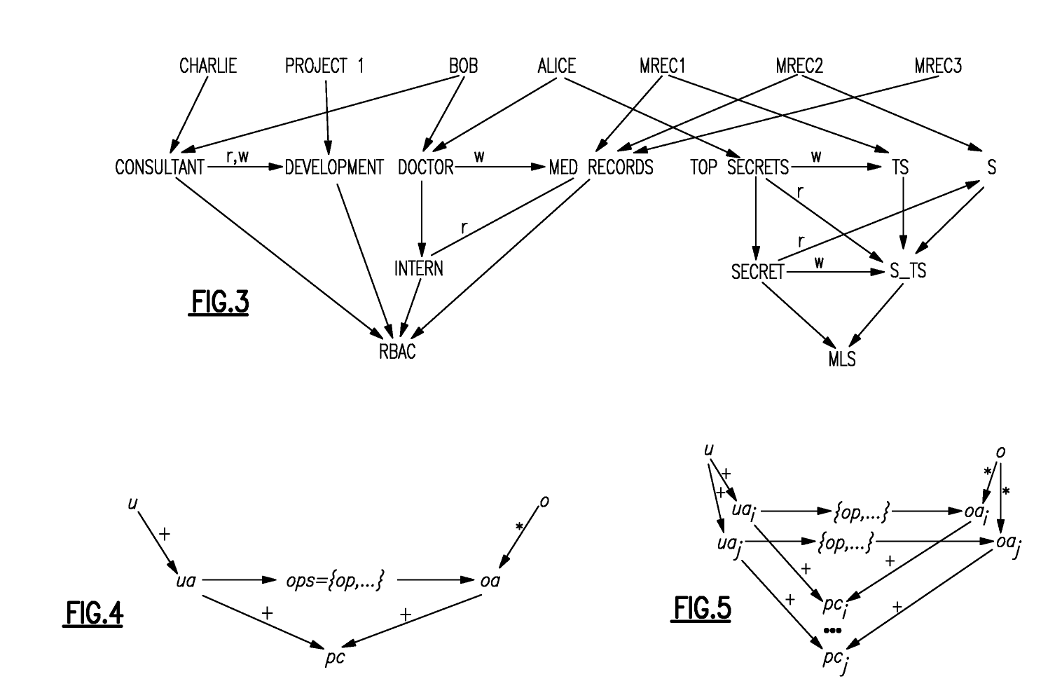

Referring to FIG. 5, a PM permission in the system 20 is a triple (u, op, o) where u is a user, op is an operation, and o is an object, and for each policy class pcₖ under which o is protected, indicating that the user u has an attribute uaₖ in pcₖ, object o has an attribute oaₖ in pcₖ, and there exists an operation set opsₖ containing op that is assigned to both uaₖ and oaₖ.

With respect to FIG. 3, the triple (alice, w, mrec2) is a permission, because (1) mrec2 is contained in both RBAC and MLS, (2) both Doctor and Secret are alice's user attributes, where Doctor is contained in RBAC and mrec2 is contained in MLS, (3) S_TS and Med Records are object attributes of mrec2, where Med Records is contained in RBAC and S_ST is contained in MLS, and (4) the operation set {w} is assigned to both Doctor and Med Records and is assigned to both Secret and S_TS. In contrast, the triple (bob, w, mrec2) is not a permission, because mrec2 is contained in both RBAC and MLS, but bob does not have an attribute in MLS.

Administrative Operations

An administrative operation simply creates, deletes, or modifies an existing policy state data relation. The set of administrative operations include, for example, create/delete user, create/remove assignment, etc. The state of the overall PM policy changes as a consequence of the execution of an administrative operation. The administrative operations are executed on behalf of a user via administrative commands (users never execute operations directly), or automatically by the system 20 in response to a recognized event. Event-response relations are described in the following section.

An administrative operation could be specified as a parameterized procedure, whose body describes how a data set or relation (denoted by R) changes to R′:

opname(x1, . . . ,xk) {

R′ = f(R, x1, . . . ,xk)

}

For example, consider the following administrative operation CreateUser:

CreateUser(u) {

U′ = U ∪ {u}

}

The CreateUser administrative operation specifies that the creation of a new user with the identifier “u” consists of augmenting the user set U with the new user identifier. Included in this specification is the fact that if a user with the same identifier already exists, the operation has no effect.

An administrative command is a parameterized sequence of administrative operations prefixed by a condition and has the format:

```
commandName(x₁, ...,xₖ)
  if (condition) then
    paop₁
    ...
    paopₙ
end
```

where x₁, . . . , xk (k≧0) are (formal) parameters and paop₁, . . . , paopₙ (n≧0) are primitive administrative operations which may use x₁, . . . , xₖ as their parameters. The condition tests, in general, whether the user who requested the execution of the command is authorized to execute the command (i.e., the composing primitive operations), as well as the validity of the actual parameters. If the condition evaluates to false, then the command fails. For example, the command that grants a user attribute a set of operations on an object container could be defined as follows:

```
grant(crt_process, ua, oa, op₁,...,opₘ)
  if (uaεUA [symbol]  oaεOA [symbol]
    ∀iε1..m opᵢεOP [symbol]
    ops ⊂ OP [symbol]
    is_auth(crt_process.user, create_opset) [symbol]
    is_auth(crt_process.user, oattr_assign_opset_to, oa) [symbol]
    is_auth(crt_process.user, uattr_assign_to_opset, ua)) then
  create_opset(ops, op1,...,opm)
  assign_opset_to_attr(ops, oa)
  assign_attr_to_opset(ua, ops)
end
```

For convenience, a command may exist inside another command.

Prohibitions

Permission relations alone are not sufficient in specifying and enforcing the current access state for many types of policies. Other policies pertain to prohibitions or exceptions to permissions. Deny relations specify such prohibitions. System 20 deny-relations take on two forms, user-based deny and process-based deny. User-based deny relations associate users with capabilities (op, o) that the user and the user's subjects are prohibited from executing. For example, although a user with the attribute IRS Auditor may be allowed to review IRS tax records, a user-based deny relation could prevent that user from reviewing his/her own tax record. Process-based deny relations associate processes with capabilities (op, o) that the processes are prohibited from executing. Process-based deny relations are usually created through the use of obligations (see below). User-based deny relations can be created either through administrative commands or through obligations.

A user-based deny relation is a triple <u, ops, os>, where u∈U, op∈2^{OP}, and os∈2^{O}. The meaning of the user-based deny is that a process executing on behalf of user u cannot perform any of the operations in ops on any of the objects in os. The set of user-based deny relations is denoted as UDENY in FIG. 2.

A process-based deny relation is a triple <p, ops, os>, where p∈P, ops∈2^{OP}, and os∈2^{O}. The meaning of the process-based deny is that the process p may not perform any of the operations in ops on any of the objects in os. The set of process-based deny relations is denoted as PDENY in FIG. 2.

Obligations

An obligation, or event pattern/response relation, defines a set of conditions and methods under which policy state data is dynamically obligated to change. An event pattern/response relation is a pair (ep, r) (usually denoted ep [symbol] r), where ep is an event pattern and r is a sequence of primitive administrative operations, called a response. The event pattern specifies conditions related to a process' successful execution of an operation on an object, using parameters like the user of the process, the operation executed, and the container(s) in which the object is included. The set of obligations is denoted as EP-R in FIG. 2.

A successful completion of an operation on an object may trigger an event. The context of the event comprises the process identifier and its user identity, the operation, the object on which the operation was performed, the object's containers, etc. The system 20 starts processing the event by determining the event patterns in the entire set of obligations that are matched by the event. The match is performed by checking whether the event context satisfies the conditions specified in the event pattern. For all successful matches, the system 20 executes the response associated with the matched pattern. Note that the possible formal parameters of the administrative operations comprised in the response are replaced by the appropriate values extracted from the event context. Responses are obligations performed by the system 20, and as such, their execution is not predicated on permissions.

The system 20 also includes a fixed set of functions that include function for user authentication, session management, presentation of accessible objects, reference mediation, and event-response processing.

Authentication

A user interaction with the system 20 begins with the user's authentication. Although authentication is included among the functions, the system's 20 specification does not dictate the method (e.g., password, tokens) by which authentication is performed. Upon authentication, a session is created where all processes included in the session are associated with the authenticated user.

A process may issue an access request on behalf of its user, or independent of its user. A process access request may be denoted by <ops, o>ₚ, where p∈P, ops⊂OP and o∈O.

Personal Object System (POS)

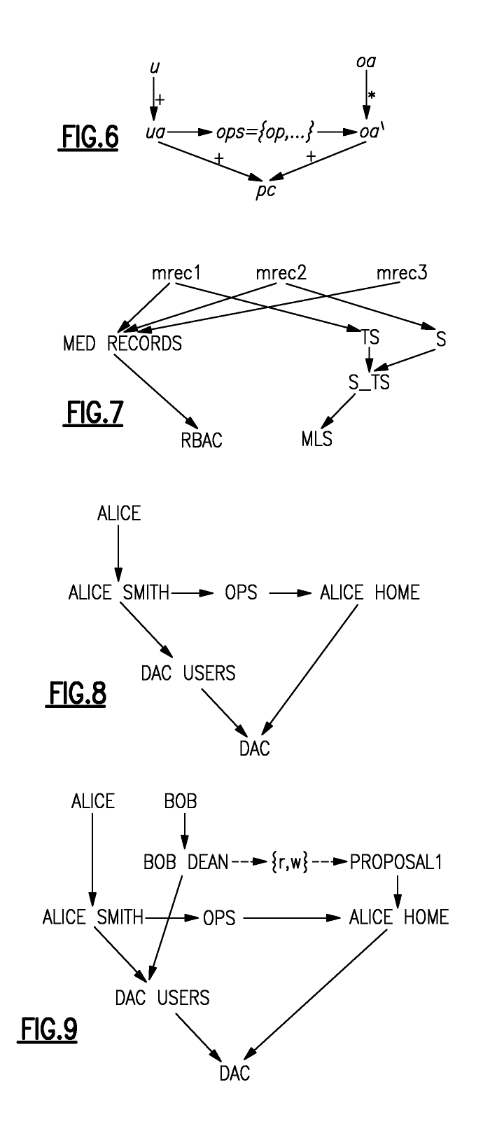

Following user authentication, the user may be presented with a Personal Object System (POS). The POS is a graphical presentation of the set of objects that are currently accessible to the user. The graphical presentation organizes accessible objects into the set of containers (object attributes) to which the objects belong and which are also accessible by the user. Remembering that objects are also object containers, an object container is accessible to a user if that user is authorized to perform the same operation op on the objects contained in that container within each policy class that container belongs to. As illustrated in FIG. 6, an object container (or attribute) represented as oa ∈OA is accessible to a user u∈U if ∃op∈OP, such that ∀pc∈PC such that oa→⁺pc, ∃ua∈UA, ∃ops∈2^{OP}, ∃oa′∈OA, such that op∈ops, u→⁺ua→ops→oa′, ua→⁺pc, and oa→*oa′→⁺pc. FIG. 7 illustrates a representation of alice's POS with respect to FIG. 3.

The personal object system of a user u, denoted by POSᵤ, is a directed graph (V, E) where the node set V is defined as follows:

1. An object attribute oa is in V if and only if oa is in a policy class and oa is accessible to user u.

2. A policy class pc is in V if and only if pc contains an object attribute accessible to u.

3. No other node is in V.

and the arc set E is defined as follows:

4. If policy class pc and object attribute oa are nodes in V, there is an arc from oa to pc if and only if oa is in pc (in the original graph) and there is no other object attribute in V on a path from oa to pc (in the original graph).

5. If object attributes oa₁ and oa₂ are nodes in V, there is an arc from oa₁ to oa₂ if and only if there is a path from oa₁ to oa₂ (in the original graph) and there is no other object attribute in Von a path from oa₁ to oa₂ (in the original graph).

6. No other arc is in E.

Reference Mediation

Either through the use of the POS or some other means of referencing objects, a user may issue a request to perform a set of operations on a set of objects, through a process. A process may also issue an access request without the intervention of a user. The server module 28 either grants or denies a process access request. A process access request to perform an operation op on an object o, with p being the process identifier, is granted if and only if there exists a permission (u, op, o) where u=process_user(p), and (op, o) is not denied (through prohibitions) for either p or u. We refer to this function of granting or denying a process access request as reference mediation.

Given process p∈P, user u=process_user(p), operation op∈OP, and object o∈O, reference_mediation(<op, o>ₚ)=grant

[symbol]

1. (u, op, o) is a permission

[symbol]

2. ∀<u, ops, os> ∈ UDENY, [symbol] (op ∈ ops [symbol] o ∈ os)

[symbol]

3. ∀<p, ops, os> ∈ PDENY, [symbol] (op ∈ ops [symbol] o ∈ os).

With respect to the definition of the capabilities and permissions in the system 20, the reference mediation function grants a process p the permission to execute a request <op, o>ₚ if and only if, in each policy class that contains the object o, the pair (op, o) is a capability of an attribute of user u=process_user(p), and in addition, this capability is not prohibited by a deny relation.

Transferring Data Between Processes

Underlying resource management systems, on which access control depends, provide facilities for inter-process communication, and as such offer opportunities to “leak” data in a manner that may undermine the policy. For example, operating systems provide mechanisms for facilitating communications and data sharing between applications. These mechanisms include but are not limited to clipboards, pipes, sockets, remote procedure calls, and messages. They all conform to a common abstraction: one process produces/creates data and inserts it into the mechanism's physical medium; the other process consumes/reads the data from the physical medium. A synchronization mechanism must also exist.

By treating the communication medium as an object, the system 20 offers strategies to support data transfer that are in compliance with the policy. For example, the producer process could create an object that represents the physical medium/support of the data transfer mechanism. This new object may be assigned attributes in accordance to a predefined and policy-specific set of conditions. These conditions can be specified via the event-response relations (e.g., if a process reads secret data, any subsequently created object will be assigned to the secret attribute). The consumer process must be able to read the object that represents the physical medium under the rules of the reference mediation.

A practical example pertains to the clipboard that is used in performing copy/cut and paste operations. When process p₁ issues the copy/cut request, the access control module 28 creates an object, say co, which represents the clipboard, with attributes that are specified in the event-response relations. The data is transferred to the clipboard as usual. When the same or different process p₂ issues the paste request, the access control module 28 naturally treats this request as a request to read from object co. As for any other process request, the access control module 28 invokes the reference mediation function to check whether p₂ is authorized to read the object co. If the request is granted by the reference mediation function, p₂ continues with the paste operation as usual.

The following examples illustrate the ability of the system 20 to support the security objectives of RBAC and MLS security models. The system 20 does not necessarily emulate the specific rules or relations of any model, but rather is able to achieve the same policy objectives of those models.

Consider the combination of the two access control policies depicted in FIG. 3, a role-based access control (RBAC) policy, and a multi-level security (MLS) policy. A known administrative objective of RBAC is to streamline authorization management by defining roles as relations between users and capabilities. These relations are achieved by assigning users to roles on one side and assigning capabilities to roles on the other side. By assigning a user to a role, that user instantaneously acquires the capabilities that are assigned to the role. Another RBAC feature is the ability to define a role hierarchy, i.e., an inheritance relation between roles, whereby senior roles acquire the capabilities of their juniors. By assigning a user to a role, the user is also (indirectly) associated with the capabilities of that role's junior roles. Finally, the RBAC standard includes two types of relations for the enforcement of separation of duties: static separation of duty (SSoD) and dynamic separation of duty (DSoD).

The system 20 meets the administrative and policy objectives of RBAC. Indeed, a user attribute in the system 20 includes the semantics of a RBAC role, i.e. by assigning a user to that user attribute, the user acquires the capabilities associated with the user attribute. Moreover, the system 20 is superior to RBAC in administrative efficiency, due to additional abstractions. In the system 20, capabilities are indirectly associated with user attributes through the double assignment user attribute-operation set-object attribute. By assigning a user to a user attribute the user is capable of performing the operations in the operation set on the objects in the container represented by the object attribute. Furthermore, the system 20 allows for the efficient association of objects with access control entries of the form (user, operation), while RBAC offers no semantics in this regard. With regard to role hierarchies, the system 20 offers semantics similar to RBAC through the user attributes assignments to other user attributes. Finally, the system 20 allows for the inheritance of access control entries between object attributes.

Considering the example in FIG. 3, the user attributes Doctor, Intern, and Consultant represent RBAC roles. The configuration includes object attributes Med Records and Development, and objects like mrec1 and project1. Under the RBAC policy, user alice's permissions are directly derived from alice's assignment to the user attribute Doctor (i.e., (alice, w, mrec1), (alice, w, mrec2), and (alice, w, mrec3)). Alice also inherits the permissions (alice, r, mrec1), (alice, r, mrec2), (alice, r, mrec3) from the assignment Doctor→Intern, which offers the same semantics as that of the role hierarchy.

Conflict of interest in a role-based system may arise as a result of a user gaining authorization for capabilities associated with conflicting roles. One means of preventing this form of conflict of interest is through static separation of duty (SSOD) to enforce constraints on the assignment of users to roles. SSoD relations place constraints on the assignments of users to roles. Membership in one role may prevent the user from being a member of one or more other roles. Dynamic separation of duty (DSoD) relations, like SSoD relations, limits the capabilities that are available to a user. However DSoD relations differ from SSD relations by the context in which these limitations are imposed. DSoD requirements limit the availability of the capabilities by placing constraints on the roles that can be activated within or across a user's sessions.

The system 20 can be programmed to provide the same security objectives as SSoD and DSoD, but through different means. Assume that a conflict of interest would arise if a user were able to execute capability (op₁, o₁) and capability (op₂, o₂). Under RBAC, these capabilities would be assigned to different roles (say r₁ and r₂) and an SSoD relation would be imposed between those roles and thus prevent any user from being simultaneously assigned to both roles. The following obligation relations in system 20 can be used to achieve this same objective:

process performs (op₁, o₁) [symbol] deny (process user, {op₂}, o₂)

process performs (op₂, o₂) [symbol] deny (process user, {op₁}, o₁)

Through these relations, any process that successfully executes (op₁, o₁) would effectively deny the process user the ability to successfully execute (op₂, o₂) in the future and vice-versa. Furthermore, in an RBAC SSD environment, while a user u₁ that is assigned to r₁ would be prevented from executing (op₂, o₂) through denial of membership to r₂, nothing prevents (op₂, o₂) from being assigned to some r₃ and u₁ being assigned to r₃.

Regarding DSoD, assume once again the capability (op₁, o₁) and capability (op₂, o₂) that are respectively assigned to r₁ and r₂. Also, assume r₁ and r₂ are in a DSoD relation in RBAC. Under these circumstances, no user may have the ability to execute both capabilities within the same session. However, a user can assume both roles in different sessions either concurrently or sequentially. Given that DSoD does not limit a user's ability to execute both capabilities within different session, we see the security objective as being that of enforcement of least privilege at the process level. Under least privilege a process should be prevented from executing (either maliciously or by error) both capabilities. The following obligation relation in system 20 can be used to achieve this same objective:

process performs (op₁, o₁) [symbol] deny (current process, {op₂}, o₂)

process performs (op₂, o₂) [symbol] deny (current process, {op₁}, o₁).

In another example, under the MLS policy, security levels organized under a dominance relation (≧), are assigned to subjects (users and their processes) and objects. The simple security property specifies that a subject is permitted read access to an object only if the subject's security level dominates the object's security level, and the *-Property specifies that a subject is permitted write access to an object only if the object's security level dominates the subject's security level. Indirectly, the *-Property prevents the transfer of data from an object of a higher level to an object of a lower classification. The security objective of these two rules is to prevent the direct and indirect reading of information at a level higher than the user's level.

FIG. 3 illustrates a configuration in system 20 that meets these security objectives in terms of permission relations and obligation relations. System 20 assumes top-secret≧secret. The permission relations of FIG. 3 specify that users cleared to the levels of top-secret and secret are respectively assigned to the Top Secret and Secret user attributes, and objects that are classified at the top-secret and secret levels are respectively assigned to the TS and S object attributes. The S_TS object attribute is a container for all objects classified at top-secret or secret levels. With respect to these permission relations alone, users (and their processes) that are assigned to Top Secret are only able to perform read operations on objects classified at the levels top secret and secret and users (and their processes) that are cleared secret are only able to perform read operations on objects classified at the level secret, thus showing support for the security objectives of the simple security property.

However, under these permission relations, a user like alice, for example, could read top secret data and subsequently write that data to a secret object. To prevent such leakage of classified information, the PM configuration of FIG. 2 comprises two event-response relations:

(1) read TS object [symbol] create deny(current process, {w}, [symbol] TS);

(2) read S object [symbol] create deny(current process, {w}, [symbol] S_TS).

The first relation specifies that whenever a process successfully reads a top-secret object, it will be denied the ability to write to objects that are not in the TS container (the [symbol] symbol stands for “the complement of”). The second relation specifies that whenever a process successfully reads a secret object, it will be denied the ability to write to objects that are not in the S_TS container (i.e., neither S nor TS).

In system 20, a process with its user cleared to a particular level (say top secret), can read objects at levels at or below the clearance level of the user (i.e., top secret, or secret). However, once a process has read data at a particular level (say top secret), that process can no longer write to objects below that particular level (i.e., secret).

Under a combination of MLS and RBAC policy instances, only processes with associated users that are Interns and Doctors and are cleared to the top secret level (e.g., alice) may perform both read and write operations on objects that are Med Records and are classified TS at the same time (e.g., mrec1).

Assume that user alice opens a session by authenticating herself to the system 20. As mentioned above, alice is presented with her POS, as depicted in FIG. 6. Further assume that alice issues a request to open the object mrec1 for reading and writing in a process executing on her behalf. The access control module 28 determines that mrec1 is protected under both RBAC and MLS policies, and that alice is authorized to access mrec1 in both policies, through her attributes Intern and Doctor of RBAC and Top Secret of MLS. The process request to read mrec1 is granted by the reference mediation function. After modifying the memory image of mrec1, alice may issue a request through her process to save (write) mrec1's contents. The request issued through that process is granted based on the same considerations as before.

The following example illustrates how a user is prevented from leaking information from a higher security level (e.g., TS) to a lower level (e.g., S) through cut/copy and paste operation with respect to the above policy configuration. Assume the following event-response relations in addition to those defined above:

(3) read TS object [symbol] create event-response(current process create object [symbol] assign new object to TS);

(4) read S object [symbol] create event-response(current process create object [symbol] assign new object to S);

() copy object [symbol] assign clipboard(current host) to attributes(current object).

The effect of relation (3) is that if a process successfully reads a top-secret object, whenever that process subsequently creates an object, the new object will be assigned to the TS attribute. The effect of relation (4) is that if a process successfully reads a secret object, whenever that process subsequently creates an object, the new object will be assigned to the S attribute. The effect of relation (5) is that if a clipboard operation “copy” is performed on a source object, the object that represents the clipboard is assigned to the attributes of the source object.

In one example, in the case when both the copy and paste operations are performed in the same process, assume that user alice issues a request to read mrec1 (TS) in a process p. The reference mediation function grants the request. At the successful completion of the read operation, a deny relation (p, {w}, [symbol] TS) is added to the policy configuration as specified by the event-response relation (1). Also, an event-response:

(3.1) p creates object [symbol] assign new object to TS

is generated according to (3). Next, alice issues a request to read mrec2 (S) in the same process p. The reference mediation function again grants the request. At the successful completion of the read operation, a deny relation (p, {w}, [symbol] S_TS) is added to the policy configuration as specified by the event-response relation (2). Also, an event-response

(4.1) p creates object [symbol] assign new object to S

is generated according to (4).

Now alice tries to copy some information from object mrec1 (TS) to object mrec2 (S) and save the latter. To copy the information from object mrec1 to the clipboard, the process p first creates an object that represents the clipboard. According to (3.1) and (4.1) the new object is assigned to both TS and S. Second, the process p actually copies the information from mrec1 to the clipboard and a “copy object” event is generated. According to relation (5), the clipboard object is assigned to all attributes of mrec1. The fact that the clipboard object is already assigned to TS does not matter. Hence, the clipboard object becomes assigned to TS, S, and Med Records.

Next, alice pastes the clipboard content to the mrec2 object. The paste action starts with a read operation from the clipboard object, which is classified TS and S. According to the event-response relations (1) and (2), the system 20 generates the deny relations (p, {w}, [symbol] TS) and (p, {w}, [symbol] S_TS). The clipboard content is pasted into the mrec2 object. Finally, alice tries to save (write) the mrec2 object. Because mrec2 is not contained in TS, one of the deny relations (p, {w}, [symbol] TS) prevents the current session from saving mrec2.

When alice tries the reverse operation, namely to copy some information from object mrec2 (S) to object mrec1 (TS) and save the latter object, it is easy to show (applying the same kind of reasoning) that she succeeds.

In another example, in the case when the copy and paste operations are performed in different processes, user alice issues a request to read mrec1 (TS) in a process p₁. The reference mediation function grants the request. At the successful completion of the read operation, a deny relation (p₁, {w}, [symbol] TS) is added to the policy configuration as specified by the event-response relation (1). Also, an event-response

(3.2) p₁ creates object [symbol] assign new object to TS

is generated according to (3). Next, alice issues a request to read mrec2 (S) in a new process p₂. The reference mediation grants the request. At the successful completion of the read operation, a deny relation (p₂, {w}, [symbol] S_TS) is added to the policy configuration as specified by the event-response relation (2). Also, an event-response:

(4.2) p₂ creates object [symbol] assign new object to S

is generated according to (4).

alice may try to copy some information from object mrec1 (top-secret) to object mrec2 (secret) and save the latter. To copy the information from object mrec1 to the clipboard, the process p₁ first creates an object that represents the clipboard. According to (3.2) and (4.2) the new object is assigned to TS. Second, the process p₁ actually copies the information from mrec1 to the clipboard and a “copy object” event is generated. According to relation (5), the clipboard object is assigned to all attributes of mrec1. The fact that the clipboard object is already assigned to TS does not matter. Hence, the clipboard object becomes assigned to TS and Med Records.

Next, alice pastes the clipboard content to the mrec2 object in process p₂. The paste action starts with a read operation from the clipboard object, which is classified TS. According to the event-response relations (1), the system 20 generates the deny relations (p₂, {w}, [symbol] TS). The clipboard content is pasted into the mrec2 object. Finally, alice tries to save (write) the mrec2 object. Because mrec2 is not contained in TS, the deny relation (p₂, {w}, [symbol] TS) prevents the current session from saving mrec2.

Another example shows that RBAC is not designed to prevent unauthorized leaking of data. For example, with respect to FIG. 3, the RBAC policy specifies that Doctors and Interns can read medical information, and this suggests that only doctors and interns can read medical information. Under this configuration, nothing prevents bob from copying the contents of mrec3 and pasting it into the object project1, which can be read by charlie who is not a Doctor or Intern. It should be noted that a malicious process acting on bob's behalf could also read medical information and write it to project1 without bob's knowledge.

To prevent this unlawful leakage, the system 20 can apply the approach that was used to prevent leakage under MLS to the context of RBAC. Consider the following event-response relation:

(6) read “Med Records” object [symbol] create deny(current process, {w}, [symbol] “Med Records”).

Relation (6) will prevent bob using a single process from reading contents of any medical record (e.g., mrec3) and subsequently writing it to any object outside the Med Records container (e.g., project1).

In a scenario where bob copies data from mrec3 and pastes it to project1 in different processes, relation (5) assigns the clipboard object to the Med Records container. The second process for the paste operation reads the clipboard object, and according to the relation (6) the system 20 generates a deny relation that prevents bob from writing (saving) project1.

In another example, under Discretionary Access Control (DAC), the user who creates an object is called the object “owner” and controls users' capabilities on that object, based on the users' or user groups' identities. The capabilities that the owner controls include operations on the object's content (e.g., read/write/execute), as well as operations that change the object's access control policy (e.g., transfer ownership of the object or grant/revoke users' access to the object).

The system 20 can be programmed to achieve the objectives of DAC policies. For example, a user's identity can be represented through a user attribute that specifies the name of the user and which has that user as its only member (i.e., the user in question is the only user assigned to this user attribute). The attribute may be called a “name attribute”. Similarly, a group identity could be specified as a user attribute that contains only the users that are members of that group. In FIG. 8, which partially illustrates a system 20 configured to achieve a DAC objective, the user attribute “Alice Smith” is user alice's name attribute, while the “DAC users” user attribute represents the group of all users included in the DAC policy class.

User's ownership and capabilities over an “owned” object can be specified under this configuration by placing the object in a container specially created for that user. We refer to this container as the user's home. For example, the object attribute “alice home” denotes the home container of user alice. The creation of a user's home must be accompanied by setting up three categories of capabilities for the user: (a) capabilities to access the content of the objects contained in the home container; (b) capabilities to perform administrative operations on the contents of the home container (e.g., object attribute to object attribute assignments, creation of new object attributes); and (c) capabilities to transfer ownership or grant/revoke other users' access to the objects inside the home container. The user, his/her home container and the capabilities (a), (b), and (c) could be conveniently created through a single administrative command—create_dac user (user id, user name). Typically, under DAC, a user initially obtains ownership and control over an object as a consequence of object creation. This can be achieved by the system 20 by defining an event-response relation where the event is the object creation and the response is the assignment of the new object to the user's home container.

Using the policy configuration described above, transferring the ownership of an object to another user may be achieved by assigning the object to the other user's home container and optionally deleting its assignment to the original owner's home. Note that the transfer requires the permission to assign objects from the original owner home to another user's home container.

Granting another user or group of users access to an object o may be achieved by the owner by creation of the assignment g→{r, w}→o where g is a user attribute that represents the other user or group of users in the DAC users. FIG. 9 shows how alice could grant user bob read/write access to one of her objects by using such assignments to bob's name attribute “Bob Dean”. Other configuration strategies exist as well.

In another example, an additional feature of the system 20 is the capability to establish a library of policy configurations. The principle is that an administrator does not need to configure policy from scratch. Once a policy (say DAC) has been defined and tested by security experts, the policy can be made available for importation and instantiation. Policy configuration can also be parameterized, providing opportunities for customization. For example, with respect to an MLS policy, the elements of the dominance relation could be parameterized, and the specific levels could be defined just prior to importation, or with respect to a DAC policy, delegation details could be defined.

The following is an example of how system 20 can be configured to offer support to an application. One type of application provides services that are independent of access control. These applications include, for example, text editors, spreadsheets, and drawing packages. Another type of application provides services through the use of an access control policy. For example, e-mail applications provide for the reading of messages and attachments through the discretionary distribution of objects, and workflow management applications provide for the reading and writing of specific documents by a prescribed sequence of users.

In the following example, the system 20 is configured to support a simple workflow application. In this example, the following activities and users or roles perform those activities sequentially.

Activity 0. A user in the “Secretary” role fills out a purchase order form and attaches a “routing slip” that specifies n≧1 users and/or roles and the order in which they must approve and sign the purchase order.

Activity k=1 to n: The user or a user in the role specified in the routing slip at position k approves and signs the purchase order.

Activity n+1: A user in the “Acquisition” role examines the purchase order before ordering the items.

It is assumed that the workflow policy also imposes the restriction “No user is allowed to sign a purchase order twice”.

In the following, we describe the system 20 configuration used to specify and enforce the policy described above.

First, the purchase order will be modeled by an object. Activity 0 performed by a user in the Secretary role consists of reading an empty form object, filling out the form and creating a purchase order object with the data from the form. Each signing activity consists of reading the purchase order object from the specified user's or role's work items, applying maybe a graphic and/or electronic signature to its content, and writing back the purchase order object. Finally, activity n+1 consists of simply reading the purchase order object. The purchase order object will not be accessible to a user unless all previous activities as specified in the sequence have been successfully completed. Note that the policy enforcement will be performed by the OS kernel, not by the application.

The system 20 configuration will include two policy classes, DAC and RBAC. The DAC policy will comprise the user identifiers, the user name attributes, and a work items object container for each user. Each user has read/write access to its work items.

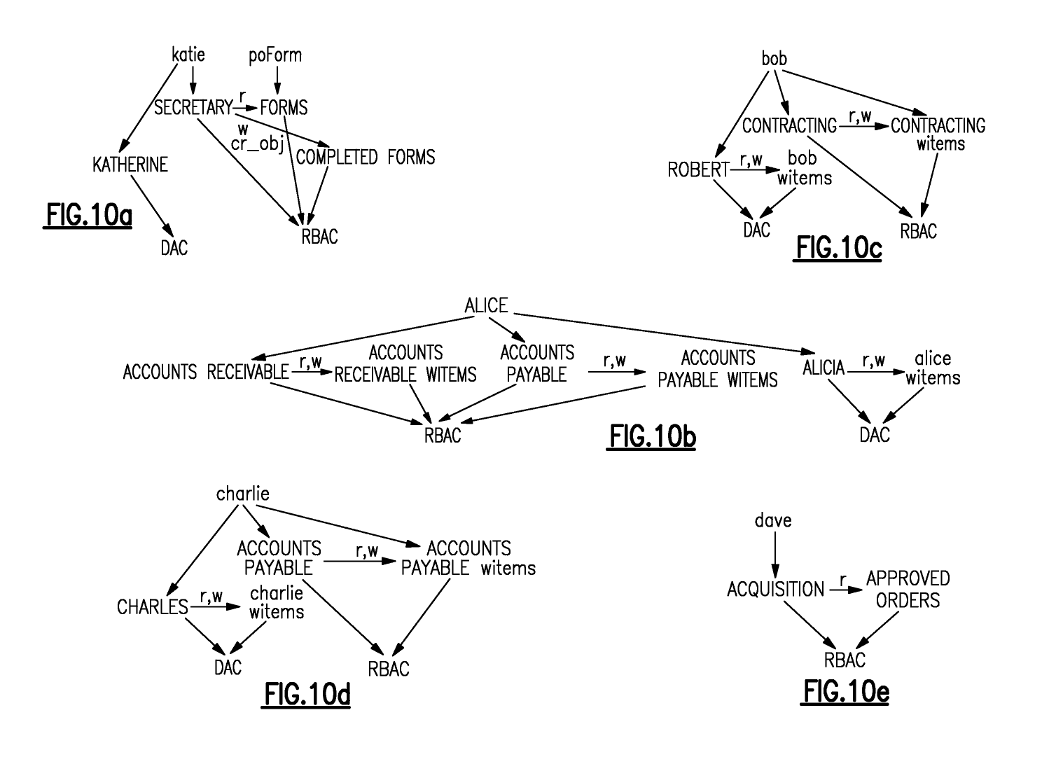

The RBAC policy will comprise the user identifiers, the Secretary role, a few “signing” roles, and the Acquisition role. The Secretary role has read access to a blank purchase order form included in the Forms container, write access to a container of Completed Forms, and the privilege of composing and registering event-response relations with the system 20. Each signing role has read/write access to its work items. The Acquisition role has read access to the container of Approved Orders. FIGS. 10a-e illustrate a configuration with three signing roles (Accounts Receivable, Contracting, and Accounts Payable) and three signing users (alice, bob, and charlie), a Secretary user, katie, and an Acquisition user, dave.

The activity sequencing will be ensured by the system 20 changing the purchase order location after each successful completion of an activity. Behind the automatic moves performed by the system 20 is an event-response script composed and registered with the system 20 by the workflow application running on behalf of the user acting in the Secretary role, just before the creation of a new purchase order.

Processing of a purchase order starts with the user katie in the Secretary role filling the empty form, attaching a routing slip, and saving the form in the “Completed Forms” container as object po121 for example. The same user also generates n+1 event-response relations that specify what should happen after the successful completion of each of the activities 0, 1, . . . , n.

This example assumes that the routing slip as composed by katie contains, in order, user alice, role Contracting, and role Accounts Payable. The event-response relation corresponding to the successful completion of activity 0 might look as follows, assuming that the first on the routing slip is user alice:

R₀: write object po121 in “Completed Forms” [symbol] assign crt_object to “alice work items”; delete assignment of crt_object to “Completed Forms.”

For an activity k with k∈1..n−1, the corresponding event-response relation might look as follows:

Rₖ: write object po121 in “Role/userₖ work items” [symbol] assign(crt_object, “Role/userₖ₊₁ work items”); delete assign(crt_object, “Role/userₖ work items”); create deny(crt_user, {w}, crt_obj).

The last administrative command prevents a user from signing twice the purchase order (actually, the user could sign the order but not save it back). Finally, for activity n the event-response relation may be as follows:

Rₙ: write object po121 in “Role/userₙ work items” [symbol] assign(crt_object, “Approved Orders”); delete assign(crt_object, “Role/userₙ work items”); delete event/response(R₀, . . . ,Rₙ).

This sends the purchase order to the “Approved orders” container, from where the Acquisition role can read it. The last command in this relation also deletes all event-response relations related to this purchase order object. For our example, the event-response relations are:

R₀: write object po121 in “Completed Forms” [symbol] assign crt_object to “alice work items”; delete assignment of crt_object to “Completed Forms”.

R₁: write object po121 in “alice work items” [symbol] assign(crt_object, “Contracting work items”); delete assign(crt_object, “alice work items”); create deny(crt user, {w}, crt_obj).

R₂: write object po121 in “Contracting work items” [symbol] assign(crt_object, “Accounts Payable work items”); delete assign(crt_object, “Contracting items”); create deny(crt user, {w}, crt_obj).

R₃: write object po121 in “Accounts Payable items” [symbol] assign(crt_object, “Approved Orders”); delete assign(crt_object, “Accounts Payable work items”); delete event/response(R₀, R₁, R₂, R₃).

As noted before, when alice performs activity 1, right after she saves the signed purchase order in her work items container, the system 20 generates a deny (alice, {w}, po121), according to the event-response relation R₁. If alice tries to sign the purchase order again as a member of the Accounts Payable role in Activity 3, she would be prevented from saving the purchase order by the above deny. Only Charlie would be able to sign po121 for the Accounts Payable role.

The system 20 provides benefits over the existing access control paradigm. For instance, the system 20 provides policy flexibility. Virtually any collection of attribute-based access control policies can be configured and enforced (e.g., DAC, MLS, Chinese wall, ORCON, object-based SoD constraints, etc.). In addition, basic application services can be provided through configuration to include those services offered by workflow management, email, and database management applications. This is in contrast to the “hard-wiring” of policy into the mechanism.

Additionally, the system 20 provides policy combinations. Resources, (objects) regardless of their type, can be selectively protected under one or more configurable policies (e.g., DAC only, or DAC and RBAC combined).

The system 20 also provides comprehensive enforcement. All user and subject (process) access requests, and all exchange of data to and from and among applications, between sessions, all exportation of data outside the bounds of the PM can be uniformly controlled under the protection policies of the objects of concern.

The system 20 also provides assurance. Configuration strategies can render malicious application code harmless, prevent unlawful leakage of data, and all enforcement could be implemented in the client module 28 but outside the user applications, e.g., at the operating system kernel level.

The system 20 also provides for policy libraries. Standard configurations for a variety of policies may be made available and new configurations can be created for immediate policy instantiation, testing and deployment. This reduces the burden on administrators in specifying and configuring policies. In addition, basic application services can be provided through configuration to include those services offered by workflow management, email, and database management applications.

The system 20 features as described herein could be provided through a number of architectural deployments to include implementation within a single operating system environment. Our reference implementation provides centralized policy configuration and decision-making within a local user environment. This kind of deployment affords still additional benefits, such as single enterprise-wide scope of protection for one administrative domain vs. policy management on an OS-by-OS and application-by-application basis. Access control policies are uniformly enforced over resources that are physically stored on a multitude of heterogeneous systems.

The system 20 also provides a true single-sign on. By virtue of the single scope of control and a personal object system that includes the ability to reference and open any resource accessible to a user (e.g., email messages, work items, files, records and fields within records), the system 20 eliminates the need for a user to authenticate to a multitude of applications and hosts.

The system 20 also provides logical access. Any accessible resource could be securely accessed through any PM compliant OS with access to an application to process the resource.

The system 20 also reduces the need for OS vendor support. To be PM compliant, all an OS vendor needs to do is implement a standard set of enforcement functions (i.e., PM authentication, user resource presentation, session management and reference mediation), and does not need to be concerned with the management of access control data, or performing access control decisions.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A general attribute-based access control system, comprising:
at least one resource server that stores and retrieves computer-accessible resources referenced by objects to and from resource repositories;
at least one client module that authenticates human users, executes programs as processes on behalf of authenticated users, requests access to the computer-accessible resources referenced by the objects, and enforces access policies with respect to the objects;
an access control database including basic data sets and basic relations between the basic data sets, the basic data sets including data corresponding to users, user attributes, objects, object attributes, operations, policy classes, and the processes, wherein the objects are names for the computer-accessible resources to which access by processes is controlled and which may be stored on the at least one resource server, and each object is also an object attribute, the operations are actions that can be performed on the computer-accessible resources and also include administrative operations that create, delete, and update elements of the basic data sets and the basic relations, and a process is an instance of a computer program being executed on behalf of any of the users, has a unique identity, and issues access requests, and the basic relations including assignments, prohibitions, and obligations, wherein the assignments collectively are representations of the capabilities of the users to perform operations on the objects, the prohibitions are representations of the capabilities of the users that are denied to the users or the processes, and the obligations are representations of conditions under which the basic data sets and the basic relations are obligated to change in a manner also prescribed in the obligations; and
at least one server module including an access decision sub-module that computes a decision whether to grant or deny access to the computer-accessible resource referenced by any of the objects to any of the processes, an event processing sub-module that processes events, and an administrative sub-module that creates, deletes, and modifies elements of the basic data sets and the basic relations.

2. The general attribute-based access control system as recited in claim 1, wherein the at least one client module includes a user authentication sub-module configured to establish an association between the human users and the data corresponding to the users of the basic data sets through an authentication scheme, a user space sub-module that executes programs as processes that issue access requests on behalf of any authenticated user, and a policy enforcement sub-module that enforces access control decisions with respect to the access requests issued by the user space sub-module, and wherein any access request issued by any of the processes is a pair composed of any of the operations and any of the objects.

3. The general attribute-based access control system as recited in claim 2, wherein the access decision sub-module comprises software configured for receiving requests for decisions from the policy enforcement sub-module of the client module, determining whether to grant or deny access based on the configuration of the access control database, and returning the decision to the policy enforcement sub-module of the client module.

4. The general attribute-based access control system as recited in claim 3, wherein the resource servers, the access control database, the client modules, and the server modules are included within one or more computer systems.

5. The general attribute-based access control system as recited in claim 4, wherein an assignment between entities can only be established between any of the users and any of the user attributes, any of the user attributes and any other of the user attributes, any of the user attributes and any of the policy classes, any first object attribute and any second object attribute where the second object attribute is not an object, any of the object attributes and any of the policy classes, any of the user attributes and any of the operations, or any set of the operations and any of the object attributes, such that no chain of assignments exists that starts and ends with the same entity, wherein the assignment relations are established by the execution of administrative operations, wherein any user, any user attribute, or any object attribute belongs to any policy class and any policy class contains any user, any user attribute, or any object attribute if there exists a chain of assignments that starts with the user, the user attribute, or the object attribute and ends with the policy class, wherein any user has any user attribute if there exists a chain of assignments that starts with the user and ends with the user attribute; and wherein any object has any object attribute if there exists a chain of assignments that starts with the object and ends with the object attribute.

6. The general attribute-based access control system as recited in claim 5, wherein the permission is any triple including any user, any of the operations, and any of the objects, derived from assignments, where for each of the policy classes containing the object, the user has a user attribute belonging to the policy class, and the object has an object attribute belonging to the policy class, and there is a set of the operations that contains the operation such that the user attribute is assigned to the set of the operations and the set of the operations is assigned to the object attribute.

7. The general attribute-based access control system as recited in claim 6, wherein any pair comprising any of the operations and any of the objects is a capability of any user if the triple including the user, the operation, and the object is one of the permissions.

8. The general attribute-based access control system as recited in claim 7, wherein the prohibition relations include user deny relations where each user deny relation is any triple comprising any of the users, any set of the operations, and any set of the objects, and process deny relations where each process deny relation is any triple comprising a process identifier, any set of the operations, and any set of the objects.

9. The general attribute-based access control system as recited in claim 8, wherein the access decision sub-module is configured with a reference mediation function that determines whether to grant or deny any access request that includes any operation and any object, the access request being issued by any process identified by a unique process identifier and being executed on behalf of a unique user, the reference mediation function grants the access request if the triple including the user, the operation, and the object is one of the permissions, and if no user-deny relation exists that includes the user, any set of the operations, and any set of the objects, where the operation included in the access request is included in the set of the operations of the user-deny relation and the object included in the access request is included in the set of the objects of the user-deny relation, and if no process-deny relation exists that includes the process identifier, any set of the operations, and any set of the objects, where the operation included in the access request is included in the set of the operations of the process-deny relation and the object included in the access request is included in the set of the objects of the process-deny relation, otherwise the reference mediation sub-module denies the access request.

10. The general attribute-based access control system as recited in claim 9, wherein each of the obligation relations is any pair that includes an event pattern and a response, where the response includes a sequence of administrative operations applied to prescribed elements of the basic sets and the basic relations, and the event pattern specifies conditions that cause the event processing sub-module to execute the administrative operations on the prescribed elements when a successful execution of any operation on any object meets the conditions.

11. The general attribute-based access control system as recited in claim 1, wherein the data of the basic data sets that corresponds to the users represents the human users.

12. A general attribute-based access control method, comprising:
selecting an attribute-based access control policy for specification and enforcement;
establishing a configuration of basic data sets in an access control database for the selected attribute-based access policy through execution of predefined administrative operations, the basic data sets including users, user attributes, operations, objects, object attributes, policy classes, and processes, the objects are names for computer-accessible resources to which access by the processes is controlled and which may be stored on a resource server, and each object is also an object attribute, the operations are actions that can be performed on a resource, and the processes are computer programs executed on behalf of any user having a unique identity and that can issue access requests; and
establishing a configuration of basic relations between the basic data sets, the basic relations including assignments, prohibitions, and obligations for the selected attribute-based access policy, through execution of the predefined administrative operations, wherein any assignment between entities can be established only between any user and any user attribute, any user attribute and any other user attribute, any user attribute and any policy class, any first object attribute and any second object attribute where the second object attribute is not one of the objects, any object attribute and any policy class, any user attribute and any set of the operations, or any set of the operations and any object attribute, such that no chain of assignments exists that starts and ends with the same entity, wherein any user, any user attribute, or any object attribute belongs to any policy class and any policy class contains any user, any user attribute, or any object attribute if there exists a chain of assignments that starts with the user or user attribute or object attribute and ends with the policy class, wherein any user has any user attribute if there exists a chain of assignments that starts with the user and ends with the user attribute, wherein any object has any object attribute if there exists a chain of assignments that starts with the object and ends with the object attribute, wherein the prohibitions include user-deny relations and process-deny relations, where each user-deny relation is any triple that includes any user, any set of the operations, and any set of the objects and where each process deny relation is any triple that includes a process identifier, any set of the operations, and any set of the objects, wherein each of the obligations is any pair that includes an event pattern and a response, where the response includes a sequence of administrative operations applied to prescribed elements of the basic data sets and basic relations, and the event pattern specifies conditions that cause an event processing sub-module to execute the administrative operations on the prescribed elements when a successful execution of any operation on any object meets the conditions.

13. The general attribute-based access control method as recited in claim 12, further comprising selectively deriving permissions from the assignments, where each permission is any triple that includes any of the users, any of the operations, and any of the objects, where for each policy class containing the object, the user has a corresponding one of the user attributes belonging to the policy class, and the object has a corresponding one of the object attributes belonging to the policy class, and there is a set of the operations that includes the operation such that the corresponding user attribute is assigned to the set of the operations and the set of the operations is assigned to the corresponding object attribute.

14. The general attribute-based access control method as recited in claim 13, further comprising:
establishing an association between a human user and a corresponding one of the users in the basic data set using an authentication scheme such that the human user becomes an authenticated user;
establishing a session for the authenticated user, where the session includes a computer environment for the execution of the processes of the authenticated user; and
establishing whether any of the objects are accessible to the authenticated user if there is any permission that includes the user, any operation, and any of the objects.

15. The general attribute-based access control method as recited in claim 14, including:
executing a computer program within any process attempting to perform any operation on any object included in the objects that are deemed accessible;
issuing an access request that includes the operation and the object that are subject to the execution attempt of the program to a policy enforcement sub-module;
sending the access request from the policy enforcement sub-module to an access decision sub-module;
determining in the access decision sub-module whether to grant or deny the access request using a reference mediation function that grants the access request if the triple that includes the authenticated user, the operation included in the access request, and the object included in the access request is any permission of the user and if no user-deny relation exists that is any triple including the authenticated user, any set of the operations, and any set of the objects, where the operation included in the access request is included in the set of the operations of the user-deny relation and the object included in the access request is included in the set of the objects of the user-deny relation, and if no process-deny relation exists that is any triple including the process identifier of the process, any set of the operations, and any set of the objects, where the operation included in the access request is included in the set of the operations of the process-deny relation and the object included in the access request is included in the set of the objects of the process-deny relation, otherwise the reference mediation function denies the access request;
communicating the decision to grant or deny the access request to the policy enforcement sub-module, including communicating a physical location of a resource referenced by the object included in the access request if the decision is to grant;
performing the operation included in the access request on the resource referenced by the object included in the access request and generating an event that includes the operation performed, the object, and a context including at least the user, the process identifier, and the object attributes that are assigned to the object for the decision to grant, or returning an error message to the process that issued the request if the decision is to deny; and
searching for any obligation relations with event patterns that match the event, and executing the administrative operations in response to each obligation relation, thereby dynamically modifying a database configuration.
